(19) United States
(12) Patent Application Publication
(10) Pub. No.: US 2026/0121935 A1
(43) Pub. Date: Apr. 30, 2026

(54) CELLULAR NETWORK OPERATOR-DEFINED NETWORK DATA ANALYTICS ENHANCEMENT

(71) Applicant: AT&T Intellectual Property I, L.P., Atlanta, GA (US)

(72) Inventors: Mohamed Khalil, Murphy, TX (US); Rohit Abhishek, Dawsonville, GA (US)

(21) Appl. No.: 18/926,153

(22) Filed: Oct. 24, 2024

(51) Int. Cl. H04L 41/14; H04L 69/22

(52) U.S. Cl. CPC H04L 41/14; H04L 69/22

(57) ABSTRACT

A processing system of a cellular network may obtain a network analytics request message from a requesting network element of the cellular network. In one example, the network analytics request message may include an analytics identifier in a type of analytics field of the network analytics request message, the analytics identifier indicating a request for operator-defined analytics, and an operator-specific analytics identifier for a first operator-defined analytics type. The processing system may next obtain analytics data of the first operator-defined analytics type, in response to the network analytics request message. The processing system may then transmit, to the requesting network element, at least one network analytics response message that includes the analytics data of the first operator-defined analytics type that is obtained.

The present disclosure relates generally to wireless communication networks, e.g., wireless cellular networks, and more particularly to methods, non-transitory computer-readable media, and apparatuses for transmitting to a requesting network element at least one network analytics response message that includes analytics data of a first operator-defined analytics type that is obtained in response to a network analytics request message, and to methods, non-transitory computer-readable media, and apparatuses for receiving in response to a network analytics request message at least one network analytics response message that includes analytics data of a first operator-defined analytics type.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. 5G is intended to deliver superior high speed and performance. However, during initial deployments, 5G may potentially suffer from limited coverage areas, higher costs of deployment, slow rollout, and more costly initial subscription plans.

### SUMMARY

In one example, the present disclosure discloses a method, computer-readable medium, and apparatus for transmitting to a requesting network element at least one network analytics response message that includes analytics data of a first operator-defined analytics type that is obtained in response to a network analytics request message. For example, a processing system including at least one processor of a cellular network may obtain a network analytics request message from a requesting network element of the cellular network. In one example, the network analytics request message may include an analytics identifier in a type of analytics field of the network analytics request message, the analytics identifier indicating a request for operator-defined analytics, and an operator-specific analytics identifier for a first operator-defined analytics type. The processing system may next obtain analytics data of the first operator-defined analytics type, in response to the network analytics request message. The processing system may then transmit, to the requesting network element, at least one network analytics response message that includes the analytics data of the first operator-defined analytics type that is obtained.

In addition, in one example, the present disclosure discloses a method, computer-readable medium, and apparatus for obtaining in response to a network analytics request message at least one network analytics response message that includes analytics data of a first operator-defined analytics type. For example, a processing system including at least one processor of a network element of a cellular network may transmit to a network data analytics network element of the cellular network, a network analytics request message. In one example, the network analytics request message may include an analytics identifier in a type of analytics field of the network analytics request message, the analytics identifier indicating a request for operator-defined analytics, and an operator-specific analytics identifier for a first operator-defined analytics type. The processing system may then receive, in response to the network analytics request message, at least one network analytics response message that includes analytics data of the first operator-defined analytics type.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example of a network analytics request message and network analytics response message in accordance with the present disclosure;

FIG. 3 illustrates a flowchart of an example method for transmitting to a requesting network element at least one network analytics response message that includes analytics data of a first operator-defined analytics type that is obtained in response to a network analytics request message;

FIG. 4 illustrates a flowchart of an example method for obtaining in response to a network analytics request message at least one network analytics response message that includes analytics data of a first operator-defined analytics type; and

FIG. 5 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for transmitting to a requesting network element at least one network analytics response message that includes analytics data of a first operator-defined analytics type that is obtained in response to a network analytics request message, and methods, computer-readable media, and apparatuses for obtaining in response to a network analytics request message at least one network analytics response message that includes analytics data of a first operator-defined analytics type. In particular, examples of the present disclosure implement a novel functionality empowering each network operator to customize their unique set of network data analytics to align with network-specific operational goals. To further illustrate, a network data analytics function (NWDAF) is a cellular core network component provided in accordance with 3^{rd} Generation Partnership Projection (3GPP) technical standards. In addition, 3GPP technical standards, such as technical standard (TS) 23.288, provide for various network analytics types that may be maintained by an NWDAF and/or that may be requested by a client network function (NF) from an NWDAF. These may include network function (NF) load analytics, network performance analytics, user equipment (UE)-related analytics, user data congestion analytics, quality of service (QoS) sustainability analytics, dispersion analytics, wireless local area network (WLAN) performance analytics, session management congestion control experience analytics, location accuracy analytics, protocol data unit (PDU) session traffic analytics, and so forth. However, network operators and equipment and/or network function (NF) vendors may be limited to these standard-defined analytics in an NWDAF-based analytics framework. In other words, NWDAFs may lack the capability of allowing network operators to tailor analytics features to suit their specific network operational goals, preferences, or constraints.

In contrast, examples of the present disclosure provide for an extension of the NWDAF network analytics feature data collection and storage capabilities, as well as the NWDAF messaging framework to include network operator-defined analytics (or operator-defined analytics). For instance, in one example, the present disclosure may expand the NWDAF messaging framework to include a new/additional analytics identifier (ID) for operator-defined analytics (e.g., “operator defined analytics” or similar). For example, an NWDAF analytics information request response message, an NWDAF analytics subscription subscribe message, and/or an NWDAF analytics subscription notify message may include the value of “operator defined analytics” in an information element (IE) for “analytics ID.” In one example, the operator-defined analytics may be structured to include a parameter value for an operator-defined analytics identifier that will distinguish a particular operator-defined analytics type from other operator-defined analytics types. In other words, the present disclosure will permit a network operator to define any number of new, network-operator specific analytics types (e.g., that are not included in the 3GPP or other standard-defined analytics types). Accordingly, in one example, the network operator may assign unique operator-specific analytics ID values to each new operator-defined analytics type, such as XYZ111, XYZ112, ABC987, etc., or the like. Accordingly, for a NF to request data for a specific operator-defined network analytics type, the NF may include in the request an analytics ID of “operator defined analytics” along with the parameter of operator-specific analytics ID of “XYZ111” (or another identifier if a different type of operator-defined network analytics is being requested). An NWDAF (or other responding NFs) may also include the same value of “operator defined analytics” in an analytics ID information element, along with the parameter value of “XYZ111” for the operator-specific analytics ID parameter/IE when providing an NWDAF analytics subscription notify message, for instance. In one example, the “operator defined analytics” information element may also include a parameter/IE for an operator identifier (e.g., “operator ID”). For instance, an operator ID value of 1 may refer to a first network operator, an operator ID value of 2 may refer to a second network operator, and so forth.

In one example, the operator ID may be used as an additional verification on the availability of data for a particular operator-specific analytics ID value. In addition, in one example, the operator ID may be used to distinguish from operator-specific analytics ID values that may overlap from one network operator to another. For instance, network operator 1 may use the parameter/value of XYZ111 to refer to an operator-defined analytics type of NF slice load information, while a second network operator may use the same parameter/value of XYZ111 to refer to an operator-defined analytics type of extended reality (XR) edge streaming analytics.

In one example, the operator-defined analytics information element, or message field, may further provide for parameters of: target analytics reporting (e.g., a value provided for this field/IE may indicate whether historic data and/or ongoing/future data is requested and/or provided), analytics target period (e.g., the time period over which data/records are requested and/or for which data/records are being reported), and/or analytics filter information (e.g., if a particular operator-defined analytics type includes multiple features, then data/records for a subset of the features may be requested, e.g., data for features A-E may be available, while data for features A-D (excluding E) may be requested).

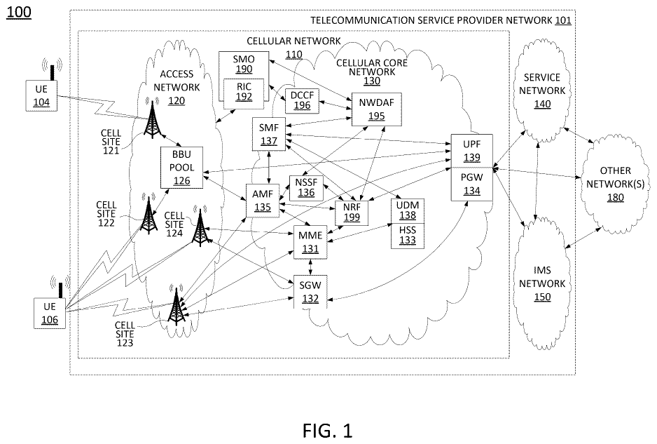

Enabling NWDAF-based operator-defined analytics in accordance with the present disclosure provides several advantages. For example, a network operator can differentiate offered services (e.g., providing one or more different services that are not offered by other networks of other network operators) by leveraging NWDAF tailored features, uniquely designed for the particular operator's needs. For instance, each network operator may possess a distinct set of analytics, distinguishing available services from those of other network operators. In addition, operator-defined analytics according to the present disclosure may accelerate time-to-market, circumventing lengthy processes of waiting for feature standardization, e.g., by 3^{rd} Generation Partnership Project (3GPP) committees or the like. Instead, network operators can swiftly integrate network analytics features into an operational cellular network without the requirement for standardization, since these features remain proprietary to each operator. Moreover, the implementation of operator-specific features offers network function (NF) vendors (e.g., vendors of physical network components/network elements and/or virtual network functions (VNFs)) with the opportunity to distinguish the services provided by their NFs by including services tailored to new operator-defined analytics. These and other aspects of the present disclosure are discussed in greater detail below in connection with the examples of FIGS. 1-5.

To better understand the present disclosure, FIG. 1 illustrates an example network, or system 100 in which examples of the present disclosure may operate. In one example, the system 100 includes a communication service provider network 101, e.g., a telecommunication service provider network. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, a network data analytics function (NWDAF) 192, and a network repository function (NRF) 199.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In accordance with the present disclosure, SMF 137 may be required to utilize NRF 199 to discover UPF instances in accordance with UPF selection functionality of the SMF 137. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”).

For instance, in non-standalone (NSA) mode architecture, LTE radio equipment may continue to be used for cell signaling and management communications, while user data may rely upon a 5G new radio (NR), including millimeter wave communications, for example. However, examples of the present disclosure relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and/or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various endpoint devices, e.g., user equipment (UE) 104 and 106. UE 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 195, NRF 199, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular core network 130 may also include a service and management orchestrator (SMO) 190. For instance, in one example, SMO 190 may comprise a self-optimizing network (SON) orchestrator and/or a software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, and of the system 100 in general. Due to the relatively large number of connections available between SMO 190 and other network elements, various actual links to the SMO 190 are omitted from illustration in FIG. 1. Similarly, intermediate devices and links between MME 131, SGW 132, cell sites 121-124, PGW 134, AMF 135, NSSF 136, SMF 137, UDM 138, NWDAF 195, NRF 199, and/or UPF 139, and other components of system 100 are also omitted for clarity, such as additional routers, switches, gateways, and the like. In one example, SMO 190 may include a RAN intelligent controller (RAN-IC or RIC) 192. For instance, in an O-RAN architecture, the RIC 192 may be deployed for managing and controlling various RAN components/functions, e.g., CUs, DUs, and RUs. For instance, RIC 192 may comprise a platform that hosts various RAN applications that may be used to configure and reconfigure various components of access network 120. In one example, aspects of RIC 192 may represent functionality of an SON orchestrator, or vice versa.

In one example, network functions (NFs), such as SMF 137, UPF 139, AMF 135, etc., may register with network repository function (NRF) 199. For instance, NRF 199 may maintain network function profiles (NFProfiles) for respective NFs, where each NFProfile may include a network function instance identifier, a network function type, a network function status, a network function instance name, a public land mobile network (PLMN) list associated with the NF, an array of S-NSSAIs supported by the NF, a list of NSIs supported by the network function, Internet Protocol addresses of the NF, a fully qualified domain name (FQDN) of the NF, and so forth. In one example, other entities, e.g., other NFs, may also subscribe to receive NF profile updates/changes from NRF 199 for one or more NFs. In such case, NRF 199 may push updates/changes to the subscribed entities, e.g., when such updates/changes are received from reporting NFs, when a threshold number of such updates/changes are received from one or multiple reporting NFs, periodically and/or when a defined period of time has elapsed, e.g., without receiving a threshold number of updates/changes from reporting NF(s), etc. Alternatively, or in addition, NFs or other entities may request NFProfile information, e.g., all or a portion of an NFProfile, or multiple NFProfiles, in response to which the NRF 199 may provide the requested NFProfile information. For instance, NWDAF 195 may subscribe to receive notification of updates to the NFProfile of an NF. Alternatively, or in addition, the NWDAF 195 (or other NFs) can make a specific request for the current NFProfile information for one or more NFs.

In one example, NWDAF 195 may comprise a data storage system, e.g., a database system. For instance, NWDAF 195 may comprise a physical network function and/or a VNF instantiated on a shared hardware device or devices (e.g., a cluster, such as a Kubernetes cluster or the like). NWDAF 195 may be tasked with monitoring various network functions, network slices, and access network components. In one example, NWDAF 195 may subscribe to network analytics data (e.g., performance indicators/KPIs) from a variety of NFs, may store these analytics, and may provide such analytics to other NFs that may request such data. In one example, NWDAF 195 may also track (e.g., subscribe to, store, etc.) various performance indicators with respect to access network 120 and/or regarding particular components thereof (such as RUs, DUs, CU, etc., e.g., cell sites 121 and 122, BBU pool 126, cell sites 123 and 124, and so forth). Accordingly, other NFs may request/subscribe to obtain network analytics data from the NWDAF 195, where the requested network analytics data may be of various types of network analytics stored by the NRF 192, may relate to selected time periods, may relate to selected network functions, and so forth, depending upon the parameters of a request from a requesting network function.

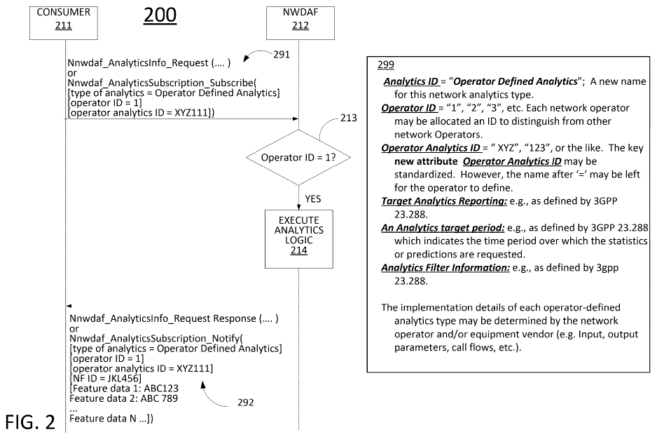

As noted above, examples of the present disclosure provide for an NWDAF messaging framework to include operator-defined analytics. For instance, an example of a network analytics request message and network analytics response message in accordance with the present disclosure are illustrated in FIG. 2 and described in greater detail below. To illustrate, an operator-defined analytics type associated with cellular network 110 and/or communication service provider network 101 may comprise NF per-slice load information. Accordingly, NWDAF 195 may maintain network slice resource usage statistics, e.g., over a period of time, for a single network slice, or a set of network slices, for one or more network slices in one or more network zones, and so forth. As such NSSF 136 may obtain slice load level analytics from NWDAF 195 (e.g., via subscribe/notify message exchange or information request/response message exchange such as illustrated in FIG. 2), which may be used by NSSF 136 to select a network slice or network slices to serve one or more endpoint devices, or may indicate one or more network slices that are permitted to be selected to serve an endpoint device. For instance, AMF 135 may query NSSF 136 for one or more network slices in response to a request from an endpoint device to establish a session to communicate with a PDN (e.g., which may be represented by other network(s) 180 in FIG. 1). The NSSF 136 may provide the selection to AMF 135, or may provide one or more permitted network slices to AMF 135, where AMF 135 may select the network slice from among the choices. In one example, AMF 135 may utilize additional information such as a UE/subscriber class or category from HSS 133. For example, when a slice is indicated to have a particular load level above a threshold, UEs/subscribers of one or more defined classes/categories may be prevented from accessing the slice, or may have preferential access to the slice over other classes/categories, and so forth.

As another example, SMO 190 and/or RIC 192 thereof may request and/or subscribe to various network analytics data that may be obtained and stored by NWDAF 195. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. To illustrate, SMO 190 may subscribe to/request network analytics data for AR/VR sessions in a tracking area, e.g., identified by a tracking area identifier (TAI) parameter value in the request, where a network analytics type of “AR/VR performance” may comprise an operator-defined analytics type. For illustrative purposes the tracking area may include cell sites 121-124 of access network 120. In one example, the request may be a network analytics subscribe request message or a network analytics information request message such as illustrated in FIG. 2 and described in greater detail below. Similarly, in one example, the response from NWDAF 195 may comprise a network analytics subscription notify message or network analytics information request response message such as illustrated in FIG. 2 and described in greater detail below. SMO 190 and/or RIC 192 may therefore obtain the requested AR/VR performance data from NWDAF 195. In addition, SMO 190 and/or RIC 192 may then configure one or more aspects of access network 120, cellular core network 130, and/or one or more network slices deployed over the infrastructure of access network 120 and cellular core network 130. For example, AR/VR sessions may typically be served via a general-purpose network slice that is used for most user data traffic.

However, if there is a number of UEs engaged in active AR/VR sessions that exceeds a threshold within a tracking area, SMO 190 may be configured to activate and/or instantiate another slice that is dedicated to AR/VR session traffic. For instance, such a slice may be optimized for AR/VR type traffic. In addition, this may benefit the general-purpose slice having throughput sensitive AR/VR traffic removed, which may improve the performance for other traffic types.

In one example, SMO 190 may subscribe to/request and obtain operator-defined analytics data or other network analytics data directly from NWDAF 195. Alternatively, or in addition, SMO 190 may subscribe to/request and obtain data for one or more operator-defined analytics types or other network analytics data from a data collection coordination and delivery function, or data collection and coordination function (DCCF) 196. For instance, DCCF 196 may process requests and/or aggregate requests from requesting/subscribing NFs, may retrieve the requested network analytics data from NWDAF 195, may distribute the requested data to the requesting/subscribing NFs, and so forth. In one example, DCCF 196 may be a sub-component of and/or co-located with NWDAF 195. In this regard, it should also be noted that in one example, NRF 199 may alternatively comprise a component of and/or may be co-located with NWDAF 195, where NRF 199 may be tasked with storing various network analytics data, and where NWDAF 195 may retrieve the stored data from NRF 199.

It should be noted that the foregoing are only several illustrative examples and that other, further, and different examples may be further provided in accordance with the present disclosure. For instance, SMO 190 may subscribe to and/or may request slice load analytics from NWDAF 195. SMO 190 may then perform various tasks in accordance with the slice load analytics, such as instantiating new instances of one or more NFs (e.g., additional UPFs, additional SMFs, and/or additional AMFs, etc.), reconfiguring one or more NFs and/or the NFVI supporting such NFs (e.g., allocating more or less processor, memory, storage, and/or other resources of a host NFVI to a particular NFs, allocating more or less processor, memory, storage, and/or other resources of an NF to a particular slice, adding one or more new slices (network slice instance(s) (NSIs) and/or deactivating one or more existing slices/NSI(s), adding or removing support for a particular slice at one or more NFs, etc.), and so forth. In one example, other entities (e.g., other NFs or the like) may also utilize the NWDAF 195 to obtain operator-defined or other network analytics data (e.g., via specific requests and/or on a subscription basis) for various purposes. In addition to maintaining various operator-defined or other network analytics data, NWDAF 195 may also make predictions, e.g., using various prediction/forecasting models, such as artificial intelligence (AI) and/or machine learning (ML) models, regression models, etc. For instance, NWDAF 195 may forecast/predict per-slice load at one or more NFs at one or more future time periods, may identify potential congestion conditions for AR/VR traffic that may trigger the allocation of additional network resources, such as instantiating new/additional VNFs, allocating BBUs, RRHs, CU, DU, or the like to one or more traffic classes, and so forth. Thus, these and other modifications, extensions, and/or alternate examples are all contemplated within the scope of the present disclosure.

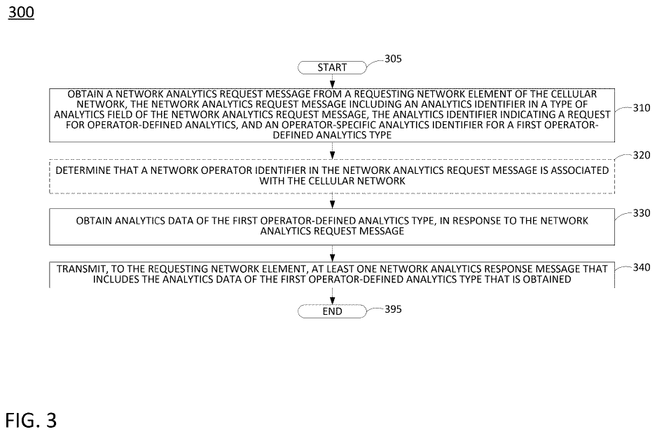

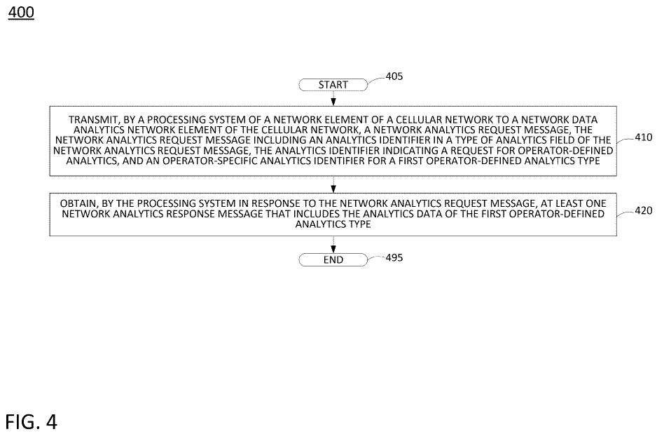

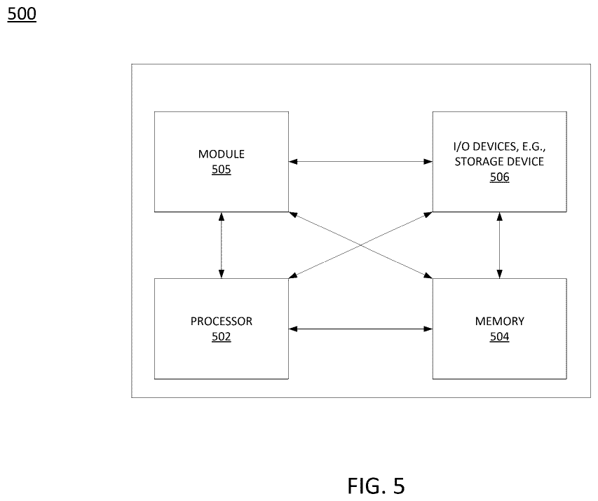

In one example, aspects of the present disclosure for transmitting to a requesting network element at least one network analytics response message that includes analytics data of a first operator-defined analytics type that is obtained in response to a network analytics request message, e.g., as described in greater detail below in connection with the example method 300 of FIG. 3, may be performed by NWDAF 195 or DCCF 196. In this regard, in one example, NWDAF 195 or DCCF 196 may comprise all or a portion of a computing device or system, such as computing system 500, and/or processing system 502 as described in connection with FIG. 5 below, and may be configured to perform various operations in connection with examples of the present disclosure for transmitting to a requesting network element at least one network analytics response message that includes analytics data of a first operator-defined analytics type that is obtained in response to a network analytics request message. Likewise, in one example, aspects of the present disclosure for obtaining in response to a network analytics request message at least one network analytics response message that includes analytics data of a first operator-defined analytics type, e.g., as described in greater detail below in connection with the example method 400 of FIG. 4, may be performed by another NF of cellular network 110 and/or of communication service provider network 110 that may request and obtain operator-defined network analytics data, such as SMO 190 and/or RIC 192, NSSF 135, SNF 137, UPF 139, and so forth. In this regard, any one or more of these NFs may comprise all or a portion of a computing device or system, such as computing system 500, and/or processing system 502 as described in connection with FIG. 5 below, and may be configured to perform various operations in connection with examples of the present disclosure for obtaining in response to a network analytics request message at least one network analytics response message that includes analytics data of a first operator-defined analytics type.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), and other application functions (AFs). Thus, these and other modifications are all contemplated within the scope of the present disclosure.

FIG. 2 illustrates an example sequence 200 of NWDAF analytics messaging in accordance with the present disclosure. In particular, the sequence 200 may include a consumer 211 (e.g., a requesting network element) transmitting a network analytics request message 291 (e.g., Nnwdaf_AnalyticsInfo_Request or Nnwdaf_AnalyticsSubscription_Subscribe) to an NWDAF 212 and receiving a response 292 (e.g., Nnwdaf_AnalyticsInfo_Request Response or Nnwdaf_AnalyticsSubscription_Notify) from the NWDAF 212. In one example, these messages may be in accordance with 3GPP TS 23.288 or the like.

However, as discussed above, the present disclosure further provides for operator-defined analytics, which may be requested in accordance with a network analytics type, e.g., operator-defined analytics. For instance, network analytics request message 291 may indicate a type of analytics as “operator-defined analytics” In addition, when this parameter is invoked, additional parameters/sub-parameters, or information elements (IEs) may be expected. These may include an operator-specific analytics identifier or “operator analytics ID,” such as XYZ111, etc. The additional parameters may also include an operator identifier (ID), which may include possible values of, e.g., 1, 2, 3, etc. For example, different network operators may use the same operator analytics ID to refer to different network analytics types. Thus, to distinguish one network operator from another, the operator ID field/IE may be used.

In one example, the NWDAF 212 receiving the network analytics request message 291 may first examine the operator identifier at 213 to confirm that the network analytics request message 291 is properly addressed to the network in which the NWDAF 212 is deployed. If not, the NWDAF 212 may return an error message (not shown in FIG. 2) to consumer 212. Alternatively, NWDAF 212 may silently fail. However, if the operator ID (e.g., “1” in this example) corresponds to the network in which NWDAF 212 is deployed, NWDAF 212 may then execute analytics logic 214 to retrieve requested network analytics data and/or to configure network functions to begin collecting the requested network analytics data. For instance, some of the network analytics data may be stored by NWDAF 212 (or in another data storage system, such as another NWDAF, an NRF, etc.). As such, NWDAF 212 may retrieve relevant network analytics data that is already stored. In addition, NWDAF 212 may transmit the retrieved network analytics data via one or more network analytics response messages 292.

Alternatively, or in addition, in some cases, the requested operator-defined analytics data may pertain to current and/or future time periods. In such case NWDAF 212 may report the requested operator-defined analytics data upon collection from one or more NFs. In one example, if the NF(s) are not presently configured to collect data pertaining to one or more features of the operator-defined network analytics type, the execution of analytics logic 214 may further include transmitting instructions to one or more NFs to configure the NFs to commence collection of the pertinent data metrics, reporting of the data metrics to NWDAF 212, etc. Upon receipt, periodically, or otherwise, NWDAF 212 may continue to update consumer 211 through transmission of one or more network analytics response messages 292.

The network analytics response message(s) 292 may include similar information elements/parameters and with similar values as contained in the request message 291 (e.g., to identify that the returned network analytics data is (1) of an operator-defined network analytics type and (2) to identify the particular type of operator-defined network analytics data, e.g., indicated by the operator analytics ID). The network analytics response message(s) 292 may further identify the operator ID associated with operator analytics ID, the network function(s) (NF(s)) to which the operator-defined network analytics data pertains, and the various data for one or more features of the operator-defined analytics type. Other parameters of the network analytics response message(s) 292 may include the relevant time period of the operator-defined network analytics data being provided.

As further illustrated in FIG. 2, key 299 illustrates operator-defined/operator-specific features of NWDAF analytics messaging in accordance with the present disclosure. For example, in the NWDAF data analytics messaging framework, the field/information element for analytics ID may be designated to specify the type of network analytics data being requested or provided. In this case, a value is designated to indicate operator-defined analytics. Accordingly, when this value is included in a data analytics message, additional parameters may further be expected in accordance with the present disclosure. For instance, this may include the operator analytics ID as discussed above, whose value may distinguish among various possible operator-defined network analytics types or from non-operator-defined network analytics. In one example, the parameters may also include an operator ID, whose value may indicate the particular network operator. In addition, various other parameters may be included, e.g., as defined in 3GPP TS 23.288 or the like, such as a target analytics reporting parameter, an analytics target period parameter, an analytics filter information parameter, and so forth. For instance, a value for a target analytics reporting parameter may indicate whether historic data and/or ongoing/future data is requested and/or provided. Similarly, for the analytics target period parameter, an included value may indicate the time period over which data/records are requested and/or for which data/records are being reported. In addition, a value for the analytics filter information parameter included in a network analytics message may indicate a subset of features of the network data analytics type being requested or provided.

It should be noted that the present disclosure may include a similar process for message exchange relating to a network function (e.g., a network element) requesting data for one or more operator-defined network analytics types from a DCCF. For instance, a DCCF data management subscribe message (e.g., Ndccf_DataManagement_Subscribe) may have a similar format and may include similar information elements/parameters and parameter values as the network analytics request message 291 to indicate a request for data of a particular type of operator-defined network analytics data. Likewise, a DCCF data management notify message (e.g., an Ndccf_DataManagement_Notify) may have a similar format and may include similar information elements/parameters and parameter values as the network analytics response message(s) 292 to indicate the network analytics data being provided, including an identification of the particular type of operator-defined network analytics data. In one example, a DCCF may initiate a back-to-back subscription to an NWDAF to obtain the network analytics data (of an operator-defined type or of a type defined according to a 3GGP standard, etc.) that the DCCF does not already possess. For instance, in one example, a DCCF may act as an intermediary for a consumer NF to access network analytic data of the NWDAF. Thus, these and other modifications are all contemplated within the scope of the present disclosure.

FIG. 3 illustrates a flowchart of an example method 300 for transmitting to a requesting network element at least one network analytics response message that includes analytics data of a first operator-defined analytics type that is obtained in response to a network analytics request message, in accordance with the present disclosure. In one example, steps, functions and/or operations of the method 300 may be performed by a device as illustrated in FIG. 1, e.g., NWDAF 195 or DCCF 196, or any one or more components thereof, such as a processing system, or collectively via a plurality devices in FIG. 1, such as NWDAF 195 or DCCF 196 in conjunction with SMO 190, AMF 135, NSSF 136, SMF 137, and/or UPF 139, and so forth. In one example, the steps, functions, or operations of method 300 may be performed by a computing device or system 500, and/or a processing system 502 as described in connection with FIG. 5 below. For instance, the computing device 500 may represent at least a portion of an NWDAF 195 or DCCF 196 in accordance with the present disclosure. For illustrative purposes, the method 300 is described in greater detail below in connection with an example performed by a processing system, such as processing system 502. The method 300 begins in step 305 and proceeds to step 310.

At step 310, the processing system, e.g., deployed in a cellular network, obtains a network analytics request message from a requesting network element (e.g., a network function (NF)) of the cellular network. For instance, the processing system may be a processing system of a network data analytics function deployed in the cellular network (e.g., an NWDAF). In such case, the network analytics request message may comprise a network analytics information request message (e.g., Nnwdaf_AnalyticsInfo_Request) or a network analytics subscription subscribe request message (e.g., Nnwdaf_AnalyticsSubscription_Subscribe). In another example, the processing system may be a processing system of a data collection coordination and delivery function (DCCF) deployed in the cellular network. In such case, the network analytics request message may comprise a DCCF data management subscribe message (e.g., Ndccf_DataManagement_Subscribe). In accordance with the present disclosure, the network analytics request message may include an analytics identifier in a type of analytics field of the network analytics request message, where the analytics identifier may contain a specific value indicating a request specifically for operator-defined analytics, and an operator-specific analytics identifier for a first operator-defined analytics type. For instance, the first operator-defined analytics type may include a load-per slice network analytics type, a VR/AR performance network analytics type, and so forth.

In one example, the network analytics request message may further include a network operator identifier associated with the operator-specific analytics identifier, where the network operator identifier is also associated with the cellular network. For instance, the network operator identifier may be one of a plurality of network operator identifiers of different 3GPP cellular network operators (e.g., “operator 1,” “operator 2,” “operator 3,” etc.). It should be noted that the particular network operator identifier may also be associated with the first operator-defined analytics type. In one example, the operator-specific analytics identifier and the network operator identifier may be contained as parameter values within an information element, or parameter of the network analytics request message for the type of analytics field. In one example, the network analytics request message may further include parameter values for one or more information elements/parameters of: a target analytics reporting type, an analytics target period, analytics filter information, and so forth.

At optional step 320, the processing system may determine that a network operator identifier in the network analytics request message is associated with the cellular network. For instance, if the processing system is deployed in a cellular network for cellular network operator “1,” at optional step 320, the processing system may inspect the network analytics request message to confirm that the value of “1” is present for the network operator identifier parameter/information element.

At step 330, the processing system obtains, in response to the network analytics subscribe request message, analytics data of the first operator-defined analytics type. In one example, the obtaining of the analytics data at step 330 may be performed further in response to determining that the network operator identifier in the network analytics request message is associated with the cellular network.

In one example in which the processing system may comprise an NWDAF, step 330 may include retrieving at least a portion of the analytics data of the first operator-defined analytics type from a storage system of the NWDAF. In another example, step 330 may include retrieving at least a portion of the analytics data of the first operator-defined analytics type from at least one storage system that is external to the NWDAF. For instance, the at least one storage system may comprise at least a second NWDAF or another repository, such as an analytics data repository function (ADRF), a network repository function (NRF), or the like. Similarly, in an example, in which the processing system may comprise a DCCF, step 330 may include obtaining the requested analytics data of the first operator-defined analytics type from an NWDAF (e.g., via a subscription request, or the like). Alternatively, or in addition, step 330 may include retrieving at least a portion of the analytics data of the first operator-defined analytics type from at least one network function of the cellular network. For example, some of the data of the first operator-defined analytics type that is requested may be either for a current or future time period. As such, the processing system may not presently possess the requested data. In addition, in one example, one or more network functions may not previously have been configured to gather and report such data. Therefore, in one example, step 330 may include transmitting instructions to the one or more network functions to begin collecting and/or reporting the requisite data to the processing system.

At step 340, the processing system transmits to the requesting network element, at least one network analytics response message that includes the analytics data of the first operator-defined analytics type that is obtained. For instance, in one example, the at least one network analytics response message may comprise a network data analytics information request response message (e.g., Nnwdaf_AnalyticsInfo_Request Response). In another example, the at least one network analytics response message may comprise a network analytics subscription notify message (e.g., Nnwdaf_AnalyticsSubscription_Notify). In still another example, the processing system may comprise a DCCF and the at least one network analytics response message may comprise a DCCF data management notify message (e.g., an Ndccf_DataManagement_Notify). In one example, the processing system may generate and transmit multiple messages. For instance, as noted above, the processing system may be tasked with first collecting some of the data of the first operator-defined analytics type that is requested. Alternatively, or in addition, the processing system may wait for future time periods to occur after which the requested data of the first operator-defined analytics type may be actualized. As such, the processing system may generate and transmit multiple messages, e.g., periodically and/or as data is collected and/or becomes available, etc.

Following step 340, the method 300 may proceed to step 395 where the method ends.

It should be noted that the method 300 may be expanded to include additional steps or may be modified to include additional operations with respect to the steps outlined above. In one example, various steps of the method 300 may be repeated for the same or different requesting network element for the same or different operator-defined network analytics data type, for different time periods, etc. In one example, the method 300 may be expanded or modified to include steps, functions, and/or operations, or other features described above in connection with the example(s) of FIGS. 1, 2, and/or 4, or as described elsewhere herein. Thus, these and other modifications are all contemplated within the scope of the present disclosure.

FIG. 4 illustrates a flowchart of an example method 400 for obtaining in response to a network analytics request message at least one network analytics response message that includes analytics data of a first operator-defined analytics type, in accordance with the present disclosure. In one example, steps, functions and/or operations of the method 400 may be performed by a device as illustrated in FIG. 1, e.g., a network function, such as SMO 190, NSSF 136, AMF 135, UPF 139, etc., or any one or more components thereof, such as a processing system, or collectively via a plurality devices in FIG. 1, such as SMO 190, NSSF 136, AMF 135, UPF 139, etc., in conjunction with NWDAF 195 and/or DCCF 196, a different one of SMO 190, NSSF 136, AMF 135, UPF 139, etc., and so forth. In one example, the steps, functions, or operations of method 400 may be performed by a computing device or system 500, and/or a processing system 502 as described in connection with FIG. 5 below. For instance, the computing device 500 may represent at least a portion of network function that may request data of one or more operator-defined analytics types in accordance with the present disclosure. For illustrative purposes, the method 400 is described in greater detail below in connection with an example performed by a processing system, such as processing system 502. The method 400 begins in step 405 and proceeds to step 410.

At step 410, the processing system, e.g., of a network element of a cellular network, transmits to a network data analytics network element of the cellular network, a network analytics subscribe request message. For instance, in one example the network data analytics network element may comprise an NWDAF. In such case, the network analytics request message may comprise a network analytics information request message (e.g., Nnwdaf_AnalyticsInfo_Request) or a network analytics subscription subscribe request message (e.g., Nnwdaf_AnalyticsSubscription_Subscribe). In another example, the network data analytics network element may comprise a data collection coordination and delivery function (DCCF). In such case, the network analytics request message may comprise a DCCF data management subscribe message (e.g., Ndccf_DataManagement_Subscribe). In accordance with the present disclosure, the network analytics request message may include an analytics identifier in a type of analytics field of the network analytics request message, the analytics identifier may contain a specific value (e.g., a value of “1”) indicating a request specifically for “operator-defined” analytics versus a different value (e.g., a value of “0”) indicating a request for “non-operator-defined” analytics (e.g., vendor-defined or standards-defined analytics), and an operator-specific analytics identifier for a first operator-defined analytics type. For instance, the first operator-defined analytics type may include a load-per slice network analytics type, a VR/AR performance network analytics type, and so forth. In one example, the network analytics request message may further include a network operator identifier associated with the operator-specific analytics identifier, where the network operator identifier is also associated with the cellular network. In one example, the operator-specific analytics identifier and the network operator identifier may be contained as parameter values within an information element, or parameter of the network analytics request message for the type of analytics field. In one example, the network analytics request message may further include parameter values for one or more parameters of: a target analytics reporting type, an analytics target period, analytics filter information, and so forth.

At step 420, the processing system obtains (e.g., from the network data analytics network element) in response to the network analytics subscribe request message, at least one network analytics subscription notify response message that includes the analytics data of the first operator-defined analytics type. For instance, in one example, the at least one network analytics response message may comprise a network data analytics information request response message (e.g., Nnwdaf_AnalyticsInfo_Request Response). In another example, the at least one network analytics response message may comprise a network analytics subscription notify message (e.g., Nnwdaf_AnalyticsSubscription_Notify). In still another example in which the network data analytics network element may comprise a data collection coordination and delivery function (DCCF), the at least one network analytics response message may comprise a DCCF data management notify message (e.g., an Ndccf_DataManagement_Notify). In one example, the processing system obtain multiple messages. For instance, the volume of analytics data may be such that the network data analytics network element may break the analytics data into multiple messages. Alternatively, or in addition, the requested analytics data may include analytics data for time periods in the future/after the request is submitted at step 410. As such, the network data analytics network element may generate and transmit multiple messages that may be received by the processing system, e.g., periodically and/or as data is collected and/or becomes available, etc. Following step 420, the method 400 may proceed to step 495 where the method 400 ends.

It should be noted that the method 400 may be expanded to include additional steps or may be modified to include additional operations with respect to the steps outlined above. In one example, various steps of the method 400 may be repeated. For instance, the processing system may continue to request network analytics data for the first operator-defined network analytics type or one or more different or additional operator-defined network analytics types. In one example, the method 400 may be expanded to further include obtaining a subscription request from the recipient network function for predicted network slice loads associated with the first network function and/or the first network slice. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not specifically specified, one or more steps, functions, or operations of the method 300 or the method 400 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 3 or FIG. 4 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 5 depicts a high-level block diagram of a computing device or processing system specifically programmed to perform the functions described herein. As depicted in FIG. 5, the processing system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for obtaining in response to a network analytics request message at least one network analytics response message that includes analytics data of a first operator-defined analytics type and/or for transmitting to a requesting network element at least one network analytics response message that includes analytics data of a first operator-defined analytics type that is obtained in response to a network analytics request message, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 506 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 505 for obtaining in response to a network analytics request message at least one network analytics response message that includes analytics data of a first operator-defined analytics type and/or for transmitting to a requesting network element at least one network analytics response message that includes analytics data of a first operator-defined analytics type that is obtained in response to a network analytics request message (e.g., a software program comprising computer-executable instructions) can be loaded into memory 504 and executed by hardware processor element 502 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for obtaining in response to a network analytics request message at least one network analytics response message that includes analytics data of a first operator-defined analytics type and/or for transmitting to a requesting network element at least one network analytics response message that includes analytics data of a first operator-defined analytics type that is obtained in response to a network analytics request message (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor of a cellular network, a network analytics request message from a requesting network element of the cellular network, wherein the network analytics request message includes:
an analytics identifier in a type of analytics field of the network analytics request message, the analytics identifier indicating a request for operator-defined analytics; and
an operator-specific analytics identifier for a first operator-defined analytics type;
obtaining, by the processing system in response to the network analytics request message, analytics data of the first operator-defined analytics type; and
transmitting, by the processing system to the requesting network element, at least one network analytics response message that includes the analytics data of the first operator-defined analytics type that is obtained.

2. The method of claim 1, wherein the processing system is a processing system of a network data analytics function deployed in the cellular network.

3. The method of claim 2, wherein the network analytics request message comprises:
a network analytics information request message; or
network analytics subscription subscribe request message.

4. The method of claim 1, wherein the processing system is a processing system of a data collection coordination and delivery function deployed in the cellular network.

5. The method of claim 4, wherein the network analytics request message comprises:
a data collection coordination and delivery function data management subscribe message.

6. The method of claim 1, wherein the network analytics request message further includes:
a network operator identifier associated with the operator-specific analytics identifier, wherein the network operator identifier is also associated with the cellular network.

7. The method of claim 6, wherein the obtaining is performed in response to determining that the network operator identifier in the network analytics request message is associated with the cellular network.

8. The method of claim 6, wherein the operator-specific analytics identifier and the network operator identifier are contained as parameter values within an information element of the network analytics request message for the type of analytics field.

9. The method of claim 1, wherein the network analytics request message further includes at least one parameter value for at least one of:
a target analytics reporting type;
an analytics target period; or
analytics filter information.

10. The method of claim 2, wherein the obtaining of the analytics data of the first operator-defined analytics type comprises:
retrieving at least a portion of the analytics data of the first operator-defined analytics type from a storage system of the network data analytics function.

11. The method of claim 2, wherein the obtaining of the analytics data of the first operator-defined analytics type comprises:
retrieving at least a portion of the analytics data of the first operator-defined analytics type from at least one storage system that is external to the network data analytics function.

12. The method of claim 1, wherein the obtaining of the analytics data of the first operator-defined analytics type comprises:
retrieving at least a portion of the analytics data of the first operator-defined analytics type from at least one network function of the cellular network.

13. A non-transitory computer-readable medium storing instructions which, when executed by a processing system including at least one processor of a cellular network, cause the processing system to perform operations, the operations comprising:
obtaining a network analytics request message from a requesting network element of the cellular network, wherein the network analytics request message includes:
an analytics identifier in a type of analytics field of the network analytics request message, the analytics identifier indicating a request for operator-defined analytics; and
an operator-specific analytics identifier for a first operator-defined analytics type;
obtaining, in response to the network analytics request message, analytics data of the first operator-defined analytics type; and
transmitting, to the requesting network element, at least one network analytics response message that includes the analytics data of the first operator-defined analytics type that is obtained.

14. A method comprising:
transmitting, by a processing system including at least one processor of a network element of a cellular network to a network data analytics network element of the cellular network, a network analytics request message, wherein the network analytics request message includes:
an analytics identifier in a type of analytics field of the network analytics request message, the analytics identifier indicating a request for operator-defined analytics; and
an operator-specific analytics identifier for a first operator-defined analytics type; and
obtaining, by the processing system in response to the network analytics request message, at least one network analytics response message that includes analytics data of the first operator-defined analytics type.

15. The method of claim 14, wherein the network data analytics network element comprises at least one of:
a network data analytics function; or
a data collection coordination and delivery function.

16. The method of claim 15, wherein the network analytics request message comprises:
a network analytics information request message; or
network analytics subscription subscribe request message.

17. The method of claim 15, wherein the network analytics request message comprises:
a data collection coordination and delivery function data management subscribe message.

18. The method of claim 14, wherein the network analytics request message further includes:
a network operator identifier associated with the operator-specific analytics identifier.

19. The method of claim 18, wherein the operator-specific analytics identifier and the network operator identifier are contained as parameter values within an information element of the network analytics request message for the type of analytics field.

20. The method of claim 14, wherein the network analytics request message further includes at least one of:
a target analytics reporting type;
an analytics target period; or
analytics filter information.
